(19) United States
(12) Patent Application Publication
(10) Pub. No.: US 2014/0357306 A1
(43) Pub. Date: Dec. 4, 2014

(54) OBJECT TRACKING SYSTEM AND METHOD THEREOF

(71) Applicant: Tiny Finder Co., Ltd., Taipei City 10477 (TW)

(72) Inventor: JIA-CHIAN SHIE, TAIPEI CITY 10477 (TW)

(73) Assignee: Tiny Finder Co., Ltd., Taipei City 10477 (TW)

(21) Appl. No.: 13/959,846

(22) Filed: Aug. 6, 2013

(30) Foreign Application Priority Data
Jun. 4, 2013 (TW) 102119747

(51) Int. Cl. H04W 64/00

(52) U.S. Cl. CPC H04W 64/00
USPC 455/457

(57) ABSTRACT

The disclosure relates to an object tracking system and method thereof. The object tracking system can track at least one positioning device through a mobile device. The mobile device includes a processing component coupled to a storage component, a master communication component, a display component, and a control component. Every positioning device includes a processing unit coupled to a control unit, a memory unit, and a slave communication unit. Accordingly, the object tracking system and method thereof may verify the current location of the positioning device, the distance between the mobile device and the positioning device as well as instantly obtain the surrounding information of the positioning device. Additionally, the positioning device may also call the mobile device thereby achieve two-way communication.

### BACKGROUND

1. Technical Field

The present disclosure relates to an object tracking system and method thereof, in particular, to an object tracking system and method thereof tracking the present situation of article(s) or person(s) through the mobile device.

2. Description of Related Art

Following the rapid development of the mobile device, the mobile device has many derivative application (ex. for global positioning system GPS, filofax, or searching data, etc) in addition to the function for sending message or the communication. Thus, the mobile device has already become an important tool for people in the life.

Furthermore, more and more people play the mobile game or chat through the mobile device. If user walks, the real-time information of the side shop can be provided by the mobile device. Or user can track the present position or situation of article(s) or person(s) through the mobile device. The application value of the mobile device can be greatly enhanced.

### SUMMARY

One objective of the instant disclosure is to provide an object tracking system and method thereof, so as to make sure of the present position of the positioning device or gain the information around the positioning device immediately. Furthermore, the object tracking system can call the mobile device through the positioning device, so as to achieve the function of the two-way call.

An exemplary embodiment of the present disclosure provides an object tracking method for tracking at least one positioning device through a mobile device, the mobile device having a master communication component and each positioning device having a slave communication unit. The steps in the method are depicted as follows.

In Step 1, in the mobile device, at least one positioning device is tracked through the communication made by the master communication component and the slave communication unit, and subsequently obtaining an identity code of each positioning device.

In Step 2, in the mobile device, a comparison is made between the comparison data and each identity code, wherein the comparison data is provided by the mobile device and an external server.

In Step 3, in the mobile device, the positioning device, linked with the mobile device, corresponds to one proprietary identity code which is with respect to the comparison data. The positional relationship between the positioning device and the mobile device may be calculated by the processor in the mobile device based on the signal energy of the identity code.

In Step 4, in the mobile device, the position of each positioning device can be displayed by the mobile device after the calculation.

According to one exemplary embodiment of the present method, the further steps in the method are as follows.

In Step 5, in the mobile device, it is determined that whether or not the distance between the mobile device and each positioning device is greater than a set value, or even though the mobile device does not receive the identity code of each positioning device. If the distance is not greater than the set value, the positions of the every positioning device and the mobile device are displayed on the display of the mobile device. If the determination is positive, a warning signal may be generated by the mobile device and delivers the warning signal to a user, for example by email. The warning signal may carry the position history of the positioning device.

According to one exemplary embodiment of the present method, the steps in the method are as follows.

In Step 5, in the mobile device, a near information of each positioning device through the external server is obtained. If the distance between the mobile device and one of the positioning devices is less than a set value, the near information of the positioning device in the mobile device can be displayed. the near information may carry map information and introduction to the near information of the positioning device.

According to one exemplary embodiment of the present method, the further steps in the method are as follows.

In Step 5, in one of the positioning devices, a call signal with the identity code is delivered through the slave communication unit and via the master communication component to the mobile device. In Step 6, in the mobile device, the call signal is compared with the comparison data; the positional relationship between the positioning device corresponding to the call signal and the mobile device is calculated according to the signal energy of the call signal; and the positional relationship can be displayed on a display of the mobile device.

in an exemplary embodiment of the present disclosure, an object tracking system is provided. The system comprises at least one positioning device and a mobile device. Wherein, each positioning device comprises a control unit, a memory unit, a slave communication unit, and a processing unit. The control unit generates a trigger signal. The memory unit stores an identity code representing the positioning device. The processing unit is electrically connected to the control unit, the memory unit, and the slave communication unit and used to activate the slave communication unit to deliver a call signal with the identity code according to the trigger signal.

The mobile device comprises a storage component, a master communication component, a display component, and a processing component. The storage component stores a comparison data with respect to the identity code of each positioning device. The master communication component is used to receive the call signal. The display component is used to display the positional relationship between the at least one positioning device and the mobile device. The processing component is electrically connected to the storage component, the master communication component, and the display component. The processing component is used to activate the display component to display the positional relationship between the positioning device corresponding to the call signal and the mobile device. When the processing unit receives the trigger signal, the processing unit activates the slave communication unit to transmit the call signal and the call signal is subsequently transmitted to the processing component through the master communication component. When the processing unit receives the call signal, the processing unit compares the call signal with the comparison data and activates the display component to display the positioning device corresponding to the call signal.

According to one exemplary embodiment, the present mobile device further comprises a control component and each positioning device, and in one embodiment a lighting unit is included. The control component is electrically connected the processing component. The lighting unit is electrically connected the processing unit. When the control component generates a search signal to the processing component, the processing component delivers the search signal to the processing unit through the master communication component and the slave communication unit. The control component may then activates the lighting unit to generate a warning light. Moreover, each positioning device further comprises a buzzer. The buzzer is electrically connected to the processing unit. When the control component generates a search signal to the processing component, the processing component delivers the search signal to the processing unit through the master communication component and the slave communication unit. The buzzer can be activated to generate a warning voice.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows the diagram of an object tracking system according to an embodiment of the invention.

FIG. 2 shows the systemic diagram of the object tracking system according to the embodiment of the invention.

FIG. 3A shows the flowchart of the object tracking method according to the embodiment of the invention.

FIG. 3B shows the diagram depicting the distance between the mobile device and the positioning device in one embodiment referring to FIG. 3A.

FIG. 3C shows the diagram depicting the control unit of the positioning device being pressed in one embodiment referring to FIG. 3A.

FIG. 4A shows the flowchart of the object tracking method according to another embodiment of the invention.

FIG. 4B shows the diagram depicting the information near the positioning device shown in the mobile device according to FIG. 4A.

FIG. 4C shows the diagram depicting the information near the positioning device shown in the mobile device according to FIG. 4A.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

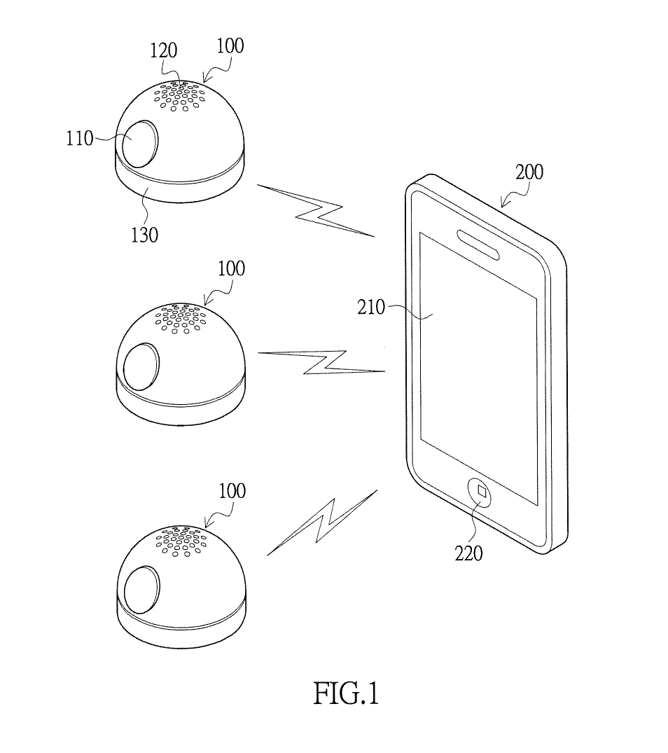

Firstly, referring to FIG. 1, FIG. 1 shows the diagram of an object tracking system. As shown in FIG. 1, the object tracking system comprises at least one positioning device 100 and a mobile device 200. The system tracks the position of the at least one positioning device 100 through the mobile device 200 or accordingly gain the information around the at least one positioning device 100 immediately. For example, the positioning device is carried by the child and the mobile device is held by his parents. When the positioning device 100 is linked to the mobile device 200 through the communication device, parents can track the position of the positioning device 100 anytime to prevent the child from getting lost.

In one further embodiment of the present invention, the object tracking system can be applied to management in a store. For example, many positioning devices 100 are placed in the different counters of the store and the mobile device 200 is held by a user. When the mobile device 200 is linked to many positioning devices 100 through the communication device, the user can accordingly gain the information of the counter around each positioning devices 100. The object tracking system of the present disclosure is explained as follows. In the present disclosure, the mobile device 200 can be a mobile phone, notebook, or any other mobile device having the function of the near field communication (NFC). It is noted that the present invention is not limited to the above examples in the disclosure.

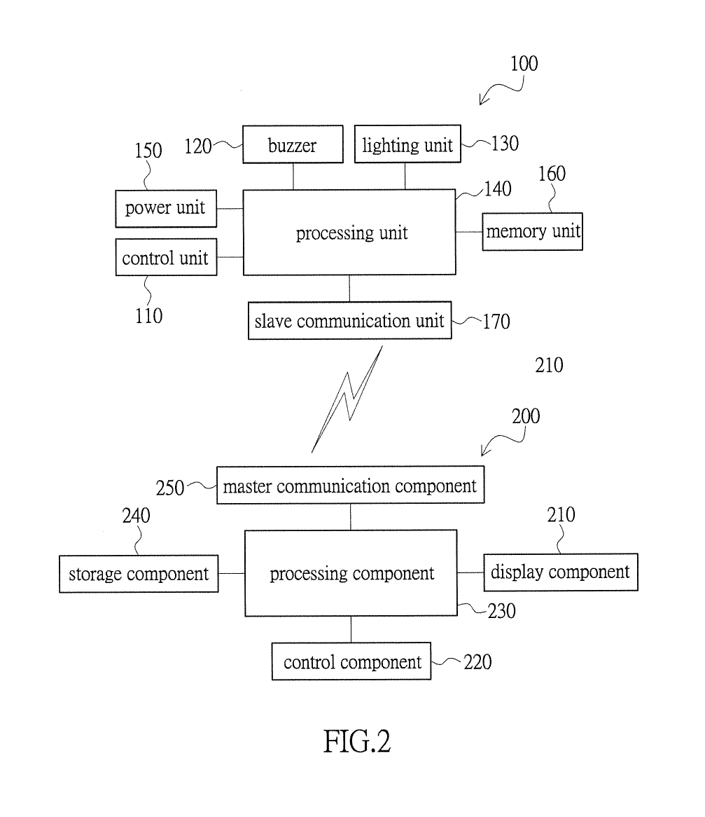

Next, referring to FIG. 2, FIG. 2 shows the systemic diagram of the object tracking system. As shown in FIG. 2, each positioning device 100 comprises a control unit 110, a buzzer 120, a lighting unit 130, a processing unit 140, a power unit 150, a memory unit 160, and a slave communication unit 170. Wherein, the control unit 110 is electrically connected the processing unit 140 and used to generate a trigger signal to the processing unit 140 to establish communication with the mobile device. In the present embodiment, the control unit 110 is, not limited to, preferably made by a button and also can be a touch panel to generate the trigger signal. The buzzer 120 electrically connected the processing unit 140 is used to generate a warning voice through the control unit 140. The lighting unit 130 electrically connected the processing unit 140 is used to generate a warning light through the processing unit 140.

The memory unit 160 stores an identity code representing the positioning device 100 for the need of the mobile device 200. The mobile device 200 accordingly makes sure the identity of the positioning device 100. The slave communication unit 170 is a bridge linking the mobile device 200. In the present embodiment, the slave communication unit 170 is preferably in compliance with Bluetooth™ communication. Other protocols such as infrared and radio frequency communication may also implement the communication.

A power unit 150 is used to supply power to the positioning device 100. In the present embodiment, the power unit 150 employs a battery, lithium battery or even the solar cell to power the positioning device 100. The processing unit 140 is electrically connected to the memory unit 160 and the slave communication unit 170 for processing the data received by the slave communication unit 170, and used to activate the slave communication unit 170 to transmit the mobile device 200.

The mobile device 200 comprises a display component 210, a control component 220, a processing component 230, a storage component 240, and a master communication component 250. Wherein, the display component 210 is electrically connected to the processing component 230 to display the positional relationship of the positioning device 100 and the mobile device 200. In the present embodiment, the positional relationship is preferably the relative position between the positioning device 100 and the mobile device 200. Besides, the absolute position of the mobile device 200 can be obtained through its wireless communication system such as WiFi™ or mobile communication protocol to download the map used for GPS. The absolute position of the positioning device 100 can be obtained through the mobile device 200. The display component 210 displays the absolute position of the mobile device 200 and the positioning device 100.

The control component 220 is electrically connected to the processing component 230 to provide a search signal to the processing component 230 and transmit the search signal to the corresponding positioning device 100. Therefore the corresponding positioning device 100 generates a response to the mobile device 200 according to the search signal. For example, when the control component 220 generates the search signal to the processing component 230, the processing component 230 transmits the search signal to the processing unit 140 of the corresponding positioning device 100 through the master communication component 250 and the slave communication unit 170. The lighting unit 130 is used to generate the warning light. For another example, when the control component 220 generates the search signal to the processing component 230, the processing component 230 subsequently transmits the search signal to the processing unit 140 of the corresponding positioning device 100 through the master communication component 250 and the slave communication unit 170. The buzzer 120 is used to generate the warning voice. In the present embodiment, the control unit 220 is preferably a button set provided to activate the positioning device 100 to generate the corresponding response. In addition, the control component 220 and the display component 210 can be combined to the display component 210 which is such as a tough panel. The display component 210 can show up the positioning device 100 which generates the corresponding response through touch control in addition to displaying the position of the positioning device 100 and the mobile device 200.

The master communication component 250 is such as a bridge linking each positioning device 100 having the slave communication unit 170. In the present embodiment, the master communication component 250 is preferably in compliance with Bluetooth™. Some other protocols may also implement the communication, for example the infrared communication and radio frequency communication. Besides, the slave communication unit 170 and the master communication component 250 should be communicative while they are required to have the same wireless communication protocol.

The storage component 240 stores a comparison data with respect to the identity code of each positioning device 100. When the mobile device 200 receives the identity code transmitted by the mobile device 100, the identity code is compared with the comparison data. Accordingly the mobile device 200 is electrically connected to the slave communication unit 170 corresponding to the identity code. Wherein, the comparison data is provided by the mobile device and an external server. For the external server obtaining the comparison data, in the present embodiment, the comparison data can be obtained from the external server through the wireless communication system such as WIFI or 3G implemented by the mobile device 200. Moreover, the comparison data can be obtained by other ways, the present invention is not limited thereto.

The processing component 230 is electrically connected to the storage component 240 and the master communication component 250 to process the data received by the master communication component 250 or to activate the master communication component 250 to transmit the data to the corresponding positioning device 100.

The method for searching the position of the at least one positioning device 100A through the mobile device 200A and sequentially comparing the mobile device 200A with the identity code of each positioning device 100A. In the present embodiment, the mobile device 200A is held by parents and the positioning device 100A can be carried by the child.

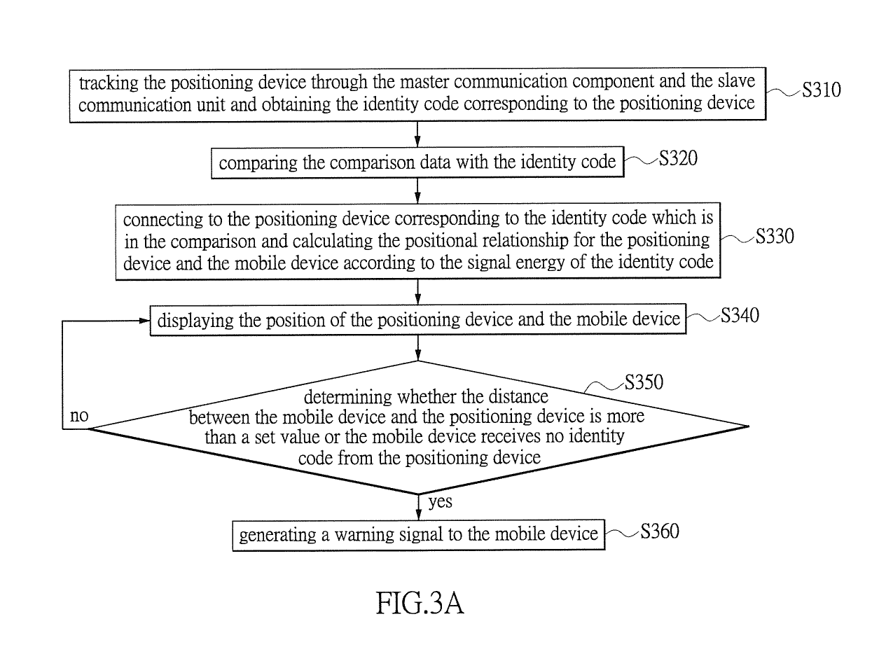

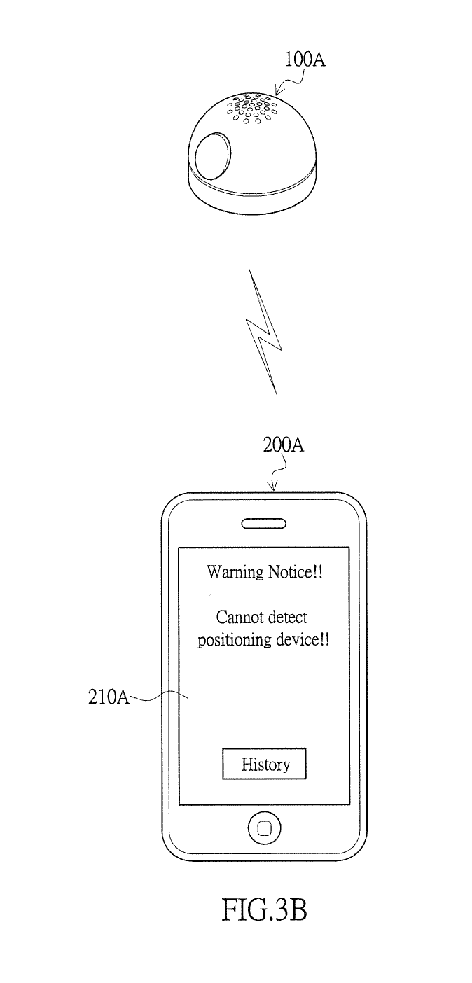

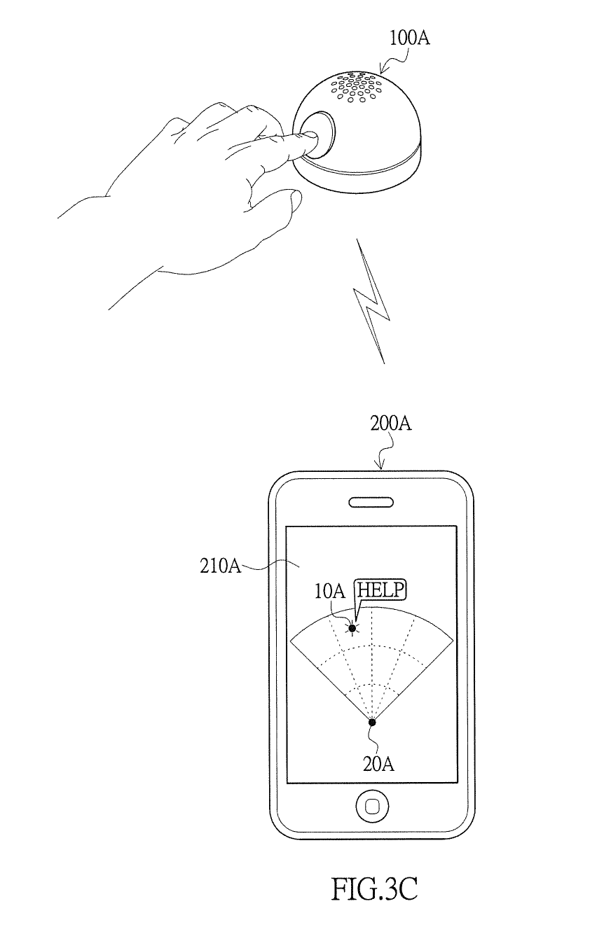

Referring to FIG. 3, firstly, the mobile device 200A tracks the positioning device 100A through the master communication component and the slave communication unit and subsequently obtains the identity code of the positioning device 100A (the step S310). Then the mobile device 200A compares the identity code with the comparison data stored in the storage component to make sure whether or not the identity code is shown in the comparison data (the step S320). If yes, the master communication component of the mobile device 200A is connected to the slave communication unit of the positioning device 100A and the positional relationship between the positioning device 100A and, the mobile device 200A is calculated according to the signal energy of the identity code (the step S330). Afterward, the positional relationship between the positioning device 100A and the mobile device 200A is displayed to the display component 210A (the step S340), as shown in FIG. 3B. In the present embodiment, the master communication component of the mobile device 200A is continuous electrically connected the slave communication unit of the positioning device 100A, so that the mobile device 200A keeps tracking the positioning device 100A.

Afterward, the mobile device 200A continuously determines whether or not the distance between the mobile device 100A and the positioning device 200A is greater than a set value or the mobile device 100A does not receive the identity code of the positioning device 200A. This step is generally to determine whether or the mobile device 100A is successfully linked with the positioning device 200A. In the present embodiment, the set value can be set by user. The preferable set value is between the 10-20 meters. The present invention is not limited thereto (the step S350). If the distance between the positioning 100A and the mobile device 200A is less than the set value or the mobile device 200A receives the identity code of the positioning device 100A, i.e. the mobile device 200A is continuously connected to the positioning device 100A, the display component 210A keeps displaying the position of the positioning device 100A and the mobile device 200A (the step S340). Otherwise, the mobile device 200A generates a warning signal. Wherein, the warning signal comprises the position history of the positioning device 100A to accordingly check the trajectory of the positioning device 100A. In the present embodiment, the warning signal can be shown in the display component 210A or delivered to the electronic mailbox of the parents or related people so as to notify them with the present situation of the child having the positioning device 100A, as shown in FIG. 3B. The present invention is not limited thereto (the step S360). At this time, the lighting unit of the positioning device 100A can be used to generate the warning light shining or the buzzer of the positioning device 100A can be used to generate the warning voice to warn the distance between the child having the positioning device 100A. That shows the parents are at a distance exceeding a limit.

To sum up, the mobile device 200A held on the parents can keep tracking the positioning device 100A placed on the child so as to accordingly track the child to avoid the child getting lost or accident.

Under the electrical connection between the master communication component of the mobile device 200A and the slave communication unit of the positioning device 100A, if the child cannot find parents yet, child can press the control unit of the positioning device 100A, as shown in FIG. 3C. At this time, the control unit generates a call signal to the processing unit. Then, the processing unit delivers the call signal with the identity code through the slave communication unit and the master communication component to the mobile device 200A. After that, the processing component of the mobile device 200A compares the call signal with the comparison data to find the positioning device corresponding to the call signal. The processing component therefore calculates the positional relationship between the positioning device 100A and the mobile device 200A according to the signal energy of the call signal. Next, the positional relationship is displayed in the display component, such as the locations of the positioning device 10A and the mobile device indicated by point 20A in the mobile device 200A, as shown in FIG. 3C. So that parents acknowledge the child was looking for him.

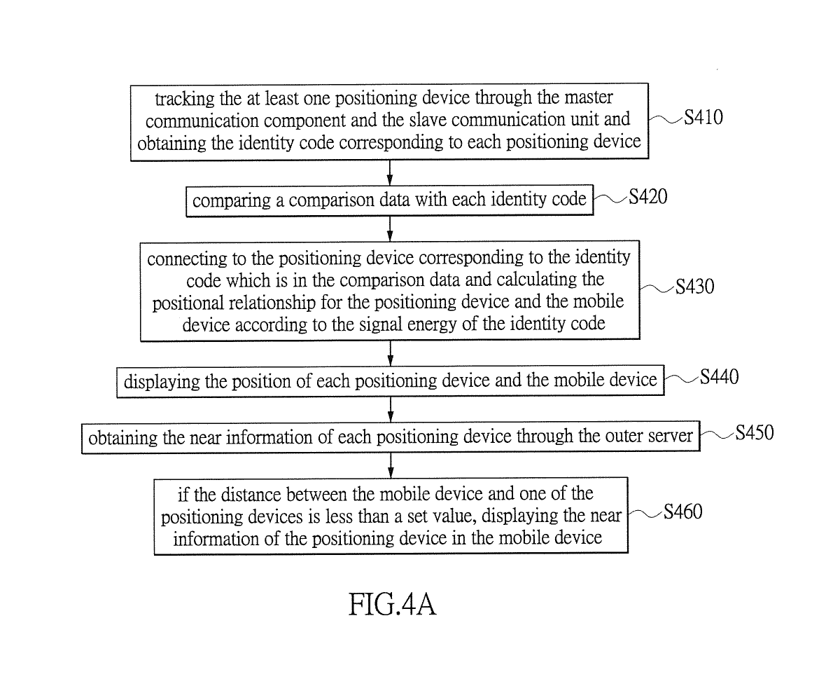

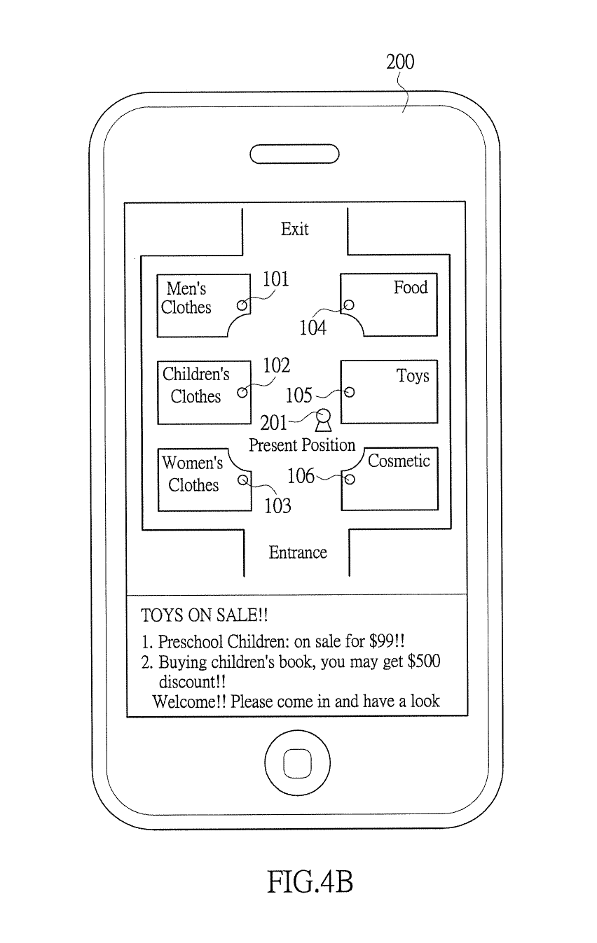

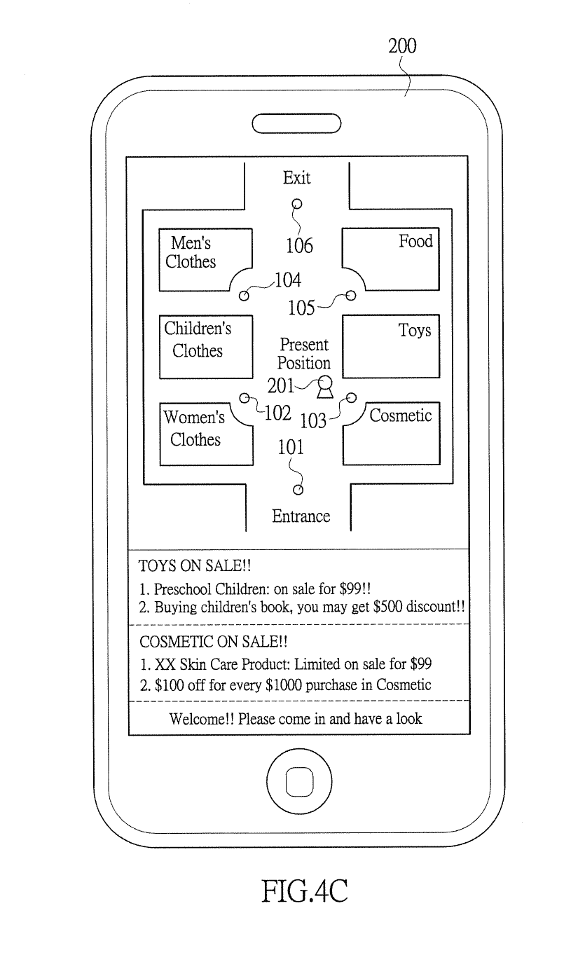

Referring to FIG. 4, the near information of the positioning device 100 which is shown in the mobile device 200 by the at least one positioning device 100 is described as follows. For convenience, a user having the mobile device 200 goes shopping in the store space. Many positioning devices 100 are placed in the different counters of the store space and each positioning device 100 has the corresponding identity code.

Firstly, the mobile device 200 tracks the positioning device 100 of the store space through the master communication component and the slave communication unit and subsequently obtains the identity code of each positioning device 100 (the step S410). Then, the mobile device 200 compares the comparison data with each identity code to make sure whether the identity code is shown in the comparison data (the step S420). Afterward, the master communication component 250 of the mobile device 200 is connected to the positioning devices 100 corresponding to the identity code through the slave communication unit 170 and the positional relationship between each positioning device 100 and the mobile device 200 is calculated according to the signal energy of the identity code. In the present embodiment, the positional relationship is the absolute position of the positioning devices 100 and the mobile device 200 (the step S430). Next, the positional relationship is displayed in the display component (the step S440). In the present embodiment, the master communication component 250 of the mobile device 200 is continuous electrically connected the slave communication unit 170 of each positioning devices 100, so that the mobile device 200 keeps tracking the positioning devices 100.

Next, the mobile device 200 gains near information of each positioning device 100 through the external server. In the present embodiment, the external server can be an exclusive server of the store space. The external server storages the map information and introduction for the near information of each positioning device 100, such as the map information for the counter corresponding to each positioning device 100, the clearance sale for the counter, and the introduction of new products, etc. (the step S450). As shown in FIG. 4B, the mobile device 200 displays the positioning device 101-106 and the present position 201 on the screen of the mobile device 200.

Afterward, the user having the mobile device 200 goes shopping in the store space. When the distance between the mobile device 200 and one of the positioning devices 100 is less than a set value, the mobile device 200 displays the near information of the positioning device 100 (the step S460). In the present embodiment, the set value can be set in the mobile device 200. The set value is preferably between the 0-10 meters. As shown in FIG. 4B, when the mobile device 200 is close to the positioning device 105, the mobile device 200 displays the near information of the positioning device 105, i.e. the relative information of the toys counter. Furthermore, as shown in FIG. 4C, the store space is zoned for the placed position of the positioning device, i.e. the positioning device 102-105 can be placed in the intermediate zone of each counter separately, the positioning device 101 can be placed in the entrance, and the positioning device 106 can be placed in the exit. Therefore, when the present position 201 of the user locates near the positioning device 103 of the store space, the mobile device 200 displays the near information of the positioning device 103, i.e. the relative information of the toys counter and cosmetic counter.

In summary, the invention is to provide an object tracking system and method thereof, which can track at least one positioning device through a mobile device so as to make sure of the present position of the positioning device or gain the information around the positioning device immediately. Furthermore, the invention can also call the mobile device through the positioning device so as to achieve the function of the two-way communication.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An object tracking method for tracking at least one positioning device through a mobile device, the mobile device having a master communication component and each positioning device having a slave communication unit, wherein the method comprising:
in the mobile device, tracking the at least one positioning device through the master communication component and the slave communication unit, and obtaining an identity code of each positioning device;
in the mobile device, comparing a comparison data with each obtained identity code, wherein the comparison data is provided by the mobile device and an external server;
in the mobile device, connecting the positioning device corresponding to the identity code which is stored in the comparison data and the mobile device, and calculating the positional relationship between the positioning device and the mobile device according to the signal energy of the identity code; and
in the mobile device, displaying the positions of the at least one positioning device and the mobile device.

2. The object tracking method according to claim 1, further comprising:
in the mobile device, determining whether or not the distance between the mobile device and the at least one positioning device is greater than a set value; or the mobile device does not receive the identity code of each positioning device; displaying the positions of each positioning device and the mobile device when the distance is not greater than the set value; generating a warning signal to the mobile device when the distance is greater than the set value.

3. The object tracking method according to claim 2, wherein the mobile device delivers the warning signal to a user with an electronic mail and the warning signal includes position history of the positioning device.

4. The object tracking method according to claim 1, further comprising:
in the mobile device, obtaining a near information of each positioning device through the external server.

5. The object tracking method according to claim 4, further comprising:
if the distance between the mobile device and one of the positioning devices is less than a set value, displaying the near information of the positioning device in the mobile device.

6. The object tracking method according to claim 4, wherein the near information includes the map information and introduction to the near information of the positioning device.

7. The object tracking method according to claim 1, further comprising:
in one of the positioning device, delivering a call signal with the identity code to the mobile device through the slave communication unit and the master communication component.

8. The object tracking method according to claim 7, further comprising:
in the mobile device, comparing the call signal with the comparison data, calculating the positional relationship between the positioning device corresponding to the call signal and the mobile device according to the signal energy of the call signal, and displaying the positional relationship in the mobile device.

9. An object tracking system, comprising:
at least one positioning device, wherein each positioning device comprising:
a control unit, used to generate a trigger signal;
a memory unit, used to store an identity code representing the positioning device;
a slave communication unit;
a processing unit, electrically connected the control unit, the memory unit, and the slave communication unit and used to activate the slave communication unit to deliver a call signal with the identity code according to the trigger signal; and
a mobile device, electrically connected each positioning device and comprising:
a storage component, used to store a comparison data having the identity code of each positioning device;
a master communication component, used to receive the call signal;
a display component, used to display the positional relationship between the at least one positioning device and the mobile device; and
a processing component, electrically connected to the storage component, the master communication component, and the display component and used to activate the display component to display the positional relationship between the positioning device corresponding to the call signal and the mobile device;
wherein, when the processing unit receives the trigger signal, the processing unit activates the slave communication unit to transmit the call signal and the call signal is transmitted to the processing component through the master communication component, and when the processing unit receives the call signal, the processing unit compares the call signal with the comparison data and activates the display component to display the positioning device corresponding to the call signal.

10. The object tracking system according to claim 9, further comprising:
a control component and each positioning device further comprising a lighting unit; the control component electrically connected the processing component, the lighting unit electrically connected the processing unit, when the control component generates a search signal to the processing component, the processing component delivers the search signal to the processing unit through the master communication component and the slave communication unit and activates the lighting unit to generate a warning light.

11. The object tracking system according to claim 9, further comprising:
a control component and each positioning device further comprising a buzzer; the control component electrically connected to the processing component, the buzzer electrically connected to the processing unit, when the control component generates a search signal to the processing component, the processing component delivers the search signal to the processing unit through the master communication component and the slave communication unit and activates the buzzer to generate a warning voice.
